(19) United States
(12) Patent Application Publication
(10) Pub. No.: US 2021/0027078 A1
(43) Pub. Date: Jan. 28, 2021

(54) LOOKING AWAY DETERMINATION DEVICE, LOOKING AWAY DETERMINATION SYSTEM, LOOKING AWAY DETERMINATION METHOD, AND STORAGE MEDIUM

(71) Applicant: NEC Corporation, Tokyo (JP)

(72) Inventors: Nana SAKUMA, Tokyo (JP); Hidenori TSUKAHARA, Tokyo (JP); Yuta SHIMIZU, Tokyo (JP)

(73) Assignee: NEC Corporation, Tokyo (JP)

(21) Appl. No.: 16/981,069

(22) PCT Filed: Feb. 1, 2019
(86) PCT No.: PCT/JP2019/003610

§ 371 Date: Sep. 15, 2020

(30) Foreign Application Priority Data
Mar. 19, 2018 (JP) 2018-051590

(51) Int. Cl. G06K 9/00; B60W 40/09; B60W 40/105; B60W 40/02

(52) U.S. Cl. CPC G06K 9/00845; G06K 9/00228; B60W 40/09; B60W 2555/20; B60W 40/02; B60W 2540/225; B60W 2520/105; B60W 40/105

(57) ABSTRACT

A looking away determination device includes: a determination unit that determines that a driver is in a looking away state when a proportion of an image in which the face of the driver is not detected with respect to a plurality of images obtained by imaging the driver is equal to or greater than a first predetermined value.

### TECHNICAL FIELD

The present invention relates to a looking away determination device, a looking away determination system, a looking away determination method and a storage medium.

### BACKGROUND ART

Patent Document 1 discloses a technique for detecting looking away of a driver operating a moving body such as an automobile.

### PRIOR ART DOCUMENTS

### Patent Documents

[Patent Document 1] PCT International Publication No. WO 2016/052507

### SUMMARY OF THE INVENTION

### Problem to be Solved by the Invention

In the above-described technique for determining looking away during driving, detection of looking away is performed on the basis of the line-of-sight direction of the face that appears in a captured image. However, when a face does not appear in the captured image, looking away determination is not performed at all. It is therefore required to appropriately perform looking away determination according to the driving situation even if a face does not appear.

An example object of the present invention is to provide a looking away determination device, a looking away determination system, a looking away determination method, and a storage medium that solves the aforementioned issue.

### Means for Solving the Problem

According to a first example aspect of the present invention, a looking away determination device includes: a determination unit that determines that a driver is in a looking away state when a proportion of an image in which the face of the driver is not detected with respect to a plurality of images obtained by imaging the driver is equal to or greater than a first predetermined value.

According to a second example aspect of the present invention, a looking away determination system includes an imaging device and a looking away determination device. the imaging device and the looking away determination device are connected by a communication network. The looking away determination device includes a determination unit that determines that a driver is in a looking away state when a proportion of an image in which the face of the driver is not detected with respect to a plurality of images obtained by imaging the driver by the imaging device is equal to or greater than a first predetermined value.

According to a third example aspect of the present invention, a looking away determination method includes: determining that a driver is in a looking away state when a proportion of an image in which the face of the driver is not detected with respect to a plurality of images obtained by imaging the driver is equal to or greater than a first predetermined value.

According to a fourth example aspect of the present invention, a storage medium that stores a program that causes a computer to execute: determining that a driver is in a looking away state when a proportion of an image in which the face of the driver is not detected with respect to a plurality of images obtained by imaging the driver is equal to or greater than a first predetermined value.

### Effect of the Invention

According to an example embodiment of the present invention, when it is determined that a face does not appear on the basis of a captured image, it is possible to determine whether or not there is a looking away in accordance with the driving situation.

### BRIEF DESCRIPTION OF THE DRAWINGS

FIG. 1 is a diagram showing a driving state monitoring system according to an example embodiment of the present invention.

FIG. 2 is a hardware configuration diagram of the looking away determination device according to the example embodiment of the present invention.

FIG. 3 is a function block diagram of the looking away determination device according to the example embodiment of the present invention.

FIG. 4 is diagram showing a hardware configuration of a drive recorder according to the example embodiment of the present invention.

FIG. 5 is a function block diagram of the control device of the drive recorder according to the example embodiment of the present invention.

FIG. 6 is a diagram showing the processing flow of the drive recorder according to the example embodiment of the present invention.

FIG. 7 is a diagram showing the processing flow of the looking away determination device according to the example embodiment of the present invention.

FIG. 8 is a diagram showing a configuration of a looking away determination device according to another example embodiment of the present invention.

### EXAMPLE EMBODIMENT

Hereinbelow, a looking away determination device according to exemplary example embodiments of the present invention will be described with reference to the drawings.

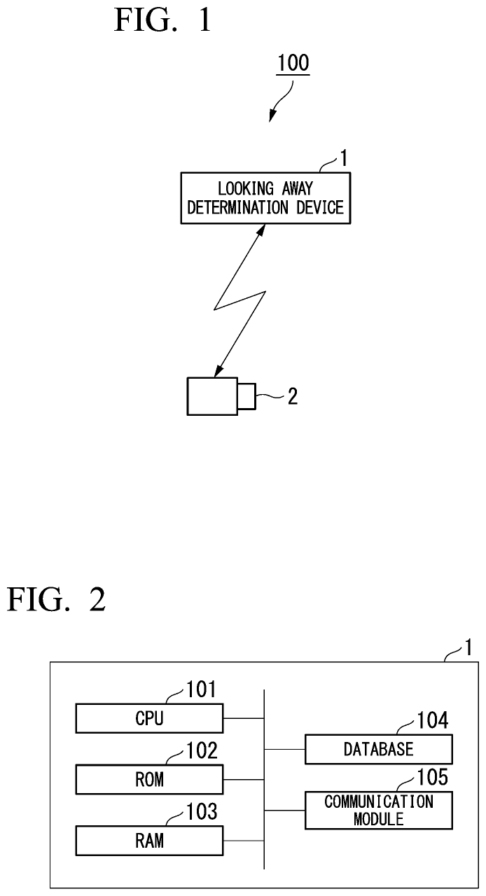

FIG. 1 is a diagram showing a driving state monitoring system according to an example embodiment of the present invention.

As shown in FIG. 1, a driving state monitoring system 100 includes a looking away determination device 1 and a drive recorder 2 that is one form of a driving state sensing device. The looking away determination device 1 and the drive recorder 2 are connected via a wireless communication network or a wired communication network. The drive recorder 2 is provided in a vehicle as an example. The looking away determination device 1 is communicatively connected to the drive recorders 2 respectively installed in a plurality of vehicles that are running throughout a city.

FIG. 2 is a hardware configuration diagram of the looking away determination device.

As shown in FIG. 2, the looking away determination device 1 is a computer including hardware such as a CPU (Central Processing Unit) 101, a ROM (Read Only Memory) 102, a RAM (Random Access Memory) 103, a database 104, and a communication module 105.

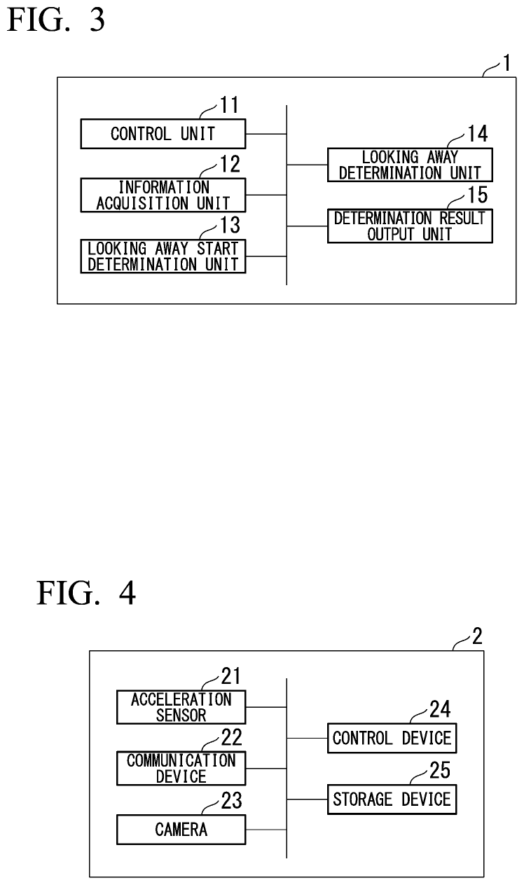

FIG. 3 is a function block diagram of the looking away determination device 1.

The looking away determination device 1 is activated when the power is turned on, and executes a looking away determination program stored in advance. As a result, the looking away determination device 1 exhibits at least the functions of a control unit 11, an information acquisition unit 12, a looking away start determination unit 13, a looking away determination unit (determination unit) 14, and a determination result output unit 15.

The control unit 11 controls other function units.

The information acquisition unit 12 acquires information transmitted from the drive recorder 2, such as captured images, vehicle information, weather information, and acceleration information.

The looking away start determination unit 13 determines whether to start looking away determination.

The looking away determination unit 14 determines that there is a looking away state when the time during which the face cannot be detected is equal to or greater than a predetermined proportion per unit time. The looking away determination unit 14 determines that there is a looking away state when the time during which the facial direction is not within a predetermined condition range is equal to or greater than the predetermined proportion per unit time. The looking away determination unit 1 determines that there is a looking away state when the time during which the facial direction is not within a predetermined condition range is equal to or greater than the predetermined proportion per unit time.

That is, the looking away determination unit 14 determines the driver to be in a looking away state when the proportion of images in which the driver's face was not detected with respect to images obtained by imaging the driver (during a unit time (predetermined period)) is equal to or greater than a predetermined value. The looking away determination unit 14 determines the driver to be in a looking away state when the proportion of images in which the facial direction of the driver is not within a predetermined condition range with respect to images obtained by imaging the driver (during a unit time (predetermined period)) is equal to or greater than a predetermined value. The looking away determination unit 14 determines the driver to be in a looking away state when the proportion of images in which the line-of-sight direction of the driver is not within a predetermined condition range with respect to images obtained by imaging the driver (during a unit time (predetermined period)) is equal to or greater than a predetermined value. Each unit time (predetermined period) may be the same or different. Moreover, each predetermined value may be the same or different.

The determination result output unit 15 outputs the looking away determination result.

FIG. 4 is a diagram showing a hardware configuration of the drive recorder 2.

The drive recorder 2 includes an acceleration sensor 21, a communication device 22, a camera 23, a control device 24, and a storage device 25. The acceleration sensor 21 detects the acceleration of the vehicle. The communication device 22 is communicatively connected to the looking away determination device 1. The camera 23 captures images of the outside or the inside of the vehicle to generate moving images and still images.

The control device 24 controls each function of the drive recorder 2. The storage device 25 stores moving images, still images, acceleration detected by the acceleration sensor 21, other information obtained from outside the drive recorder 2, and the like. The drive recorder 2 is communicatively connected to the looking away determination device 1 via a base station or the like. The control device 24 of the drive recorder 2 is a computer including a CPU, ROM, RAM and the like.

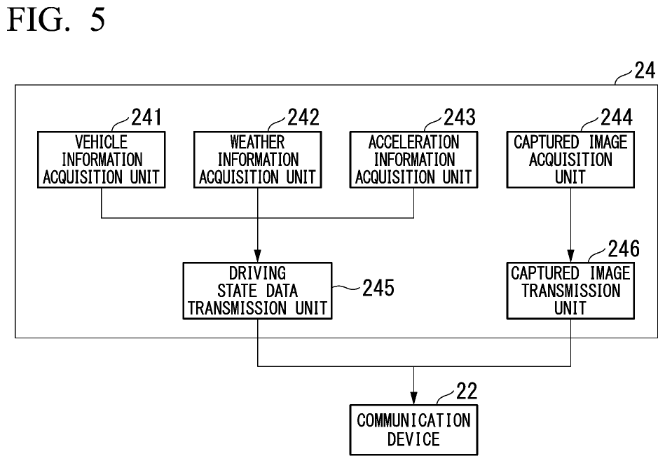

FIG. 5 is a function block diagram of the control device 24 provided in the drive recorder 2.

The control device 24 executes the control program when the drive recorder starts up. As a result, the control device 24 is capable of functioning as a vehicle information acquisition unit 241, a weather information acquisition unit 242, an acceleration information acquisition unit 243, a captured image acquisition unit 244, a driving state data transmission unit 245, and a captured image transmission unit 246.

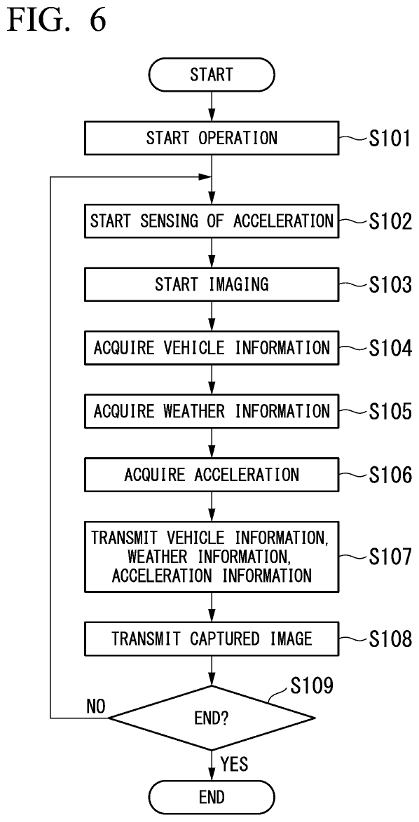

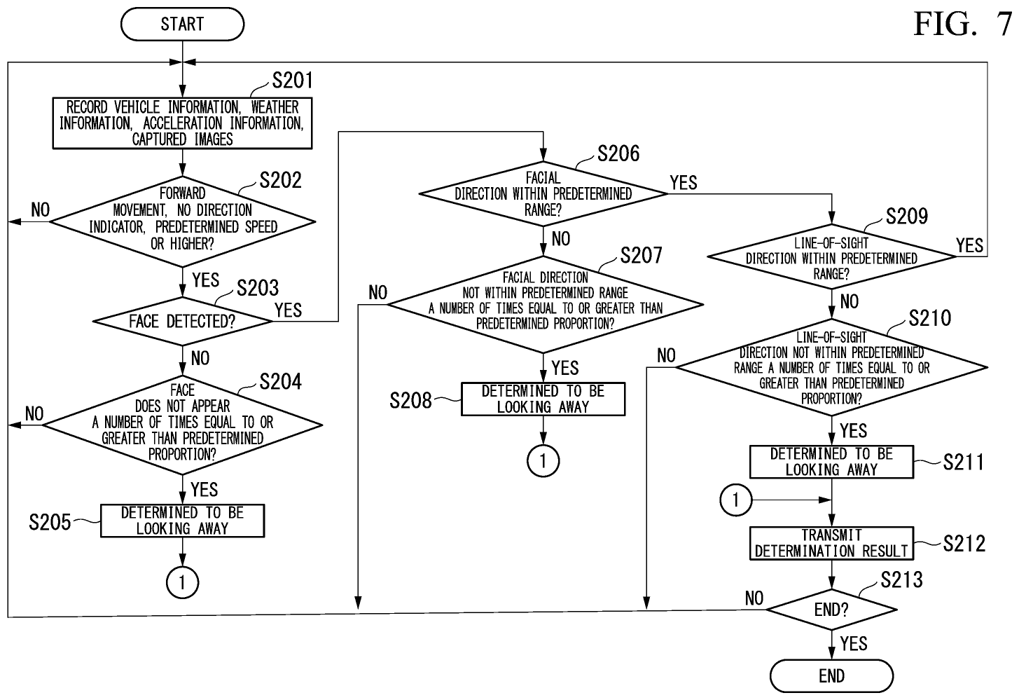

FIG. 6 is a diagram showing the processing flow of the drive recorder 2.

Next, the processing flow of the driving state monitoring system will be explained step by step.

First, the transmission process for the driving state information in the drive recorder 2 will be described.

When the electrical system of the vehicle is activated, the drive recorder 2 commences operation (Step S101). The acceleration sensor 21 of the drive recorder 2 starts sensing acceleration of the vehicle after the drive recorder 2 is started (Step S102). Further, the camera 23 starts imaging the inside of the vehicle and the outside of the vehicle (Step S103). The camera 23 includes a vehicle inside lens and a vehicle outside lens. The camera 23 uses the vehicle inside lens to capture an image of an object in the direction toward the driver's face in the vehicle (a rearward scene in the traveling direction (including the driver's face)). The camera 23 uses the vehicle outside lens to capture an image of an object in the traveling direction outside the vehicle.

Then, during operation of the drive recorder 2, the vehicle information acquisition unit 241 of the control device 24 acquires vehicle information (Step S104). The vehicle information acquired by the vehicle information acquisition unit 241 may be the vehicle speed, steering wheel angle, turn indicator direction, and the like detected by each sensor provided in the vehicle. The weather information acquisition unit 242 acquires weather information (Step S105). The weather information may be acquired from a server device provided in the Meteorological Agency or a weather information provider. Alternatively, the weather information may be information obtained from a sensor (wiper operation detector or raindrop detector) provided in the vehicle. The control device 24 may determine that the weather is rainy when the wiper is operating or when the raindrop detector detects raindrops. The acceleration information acquisition unit 243 acquires acceleration from the acceleration sensor 21 at predetermined time intervals (Step S106). The control device 24 acquires vehicle information, weather information, and acceleration at predetermined intervals.

The driving state data transmission unit 245 instructs the communication device 22 to transmit the vehicle information, the weather information, and the acceleration information to the looking away determination device 1 at predetermined intervals. The communication device 22 transmits the vehicle information, weather information, and acceleration information to the looking away determination device 1 (Step S107). The captured image transmission unit 246 instructs the communication device 22 to transmit captured images to the looking away determination device 1. The communication device 22 transmits the captured images to the looking away determination device 1 (Step S108). The control device 24 determines whether the processing is ended (Step S109), and repeats the processing from Step S102 until the processing is completed. The vehicle information, the weather information, the acceleration information, and the captured images may be provided with the ID of the drive recorder 2, the ID of the driver, and the sensing time (the time when the drive recorder 2 performed image capture). In the aforementioned process, the acceleration and weather information are transmitted. However, when looking away determination is performed based only by the vehicle information, such information need not be transmitted.

FIG. 7 is a diagram showing the processing flow of the looking away determination device 1.

In the looking away determination device 1, on the basis of the ID of the drive recorder 2 and the ID of the driver, the information acquisition unit 12 successively records in the database 104 a set of the corresponding vehicle information, weather information, acceleration information, and captured images in association with each ID (Step S201). Then, the control unit 11 instructs the looking away start determination unit 13 and the looking away determination unit 14 to perform the looking away determination process.

The looking away start determination unit 13 specifies one drive recorder 2 and acquires the sensing time, vehicle information, weather information, acceleration information, and captured images that are recorded in association with that ID. The looking away determination unit 14 determines whether the vehicle speed included in the vehicle information indicates a speed in the forward direction (forward movement), the direction indicator (turn signal) is not specifying a direction (turning direction), and the vehicle is at a predetermined speed or higher (Step S202). The predetermined speed may be a value such as 20 km/h, for example. The looking away determination unit 14 makes a decision to start the looking away determination when the vehicle speed indicates forward movement, the direction indicator does not designate a direction, and the vehicle is at or above the predetermined speed.

The looking away start determination unit 13 may decide to start the looking away determination by using other information or by additionally using other information. For example, the looking away determination unit 14 may determine whether the acceleration is zero (0) or more, and may decide to start the looking away determination when the acceleration is zero (0) or more. The looking away determination unit 14 may decide to start the looking away determination depending on whether the steering wheel angle is within a predetermined range. The predetermined range of the steering wheel angle may be, for example, within a range of 10 degrees to the left and right with the straight-ahead direction serving as a standard. The looking away determination unit 14 may decide to start the looking away determination when the weather information indicates rain. The looking away determination unit 14 may decide to start the looking away determination based on a captured image outside the vehicle. For example, when an object appears in the straight-ahead direction of the captured image, or when a curve of the lane appears in the captured image, a decision to start the looking away determination may be made. When the looking away determination unit 14 makes the decision to start the looking away determination, the looking away determination unit 14 instructs the start. The looking away determination unit 14 repeats the process of determining whether to start the looking away determination at predetermined intervals.

The looking away determination unit 14 receives, from that information acquisition unit 12, a captured image that has already been acquired by the information acquisition unit 12 on the basis of the ID of the drive recorder 2 that is the current processing target. Upon having made the decision to start the looking away determination, the looking away determination unit 14 successively reads the captured images received from the drive recorder 2 at a predetermined interval.

When reading a captured image, the looking away determination unit 14 performs face detection processing to determine whether a face is included in the captured image to an extent allowing the continuation of looking away determination. The looking away determination unit 14 determines whether or not a face can be detected in the newly acquired captured image (Step S203). Upon having detected a face in the newly acquired captured image, the looking away determination unit 14 performs the following facial direction detection processing. When the looking away determination unit 14 cannot detect a face in the newly acquired captured image, the looking away determination unit 14 determines whether a face does not appear a number of times equal to or greater than a predetermined proportion, for images captured at the sensing time up to a predetermined period (for example, 1 second) in the past with the sensing time of the newly acquired captured image serving as a standard (Step S204). With respect to captured images acquired during the predetermined period (for example, 1 second), the looking away determination unit 14 determines that the driver is looking away when a face does not appear in a number of images equal to or greater than the predetermined proportion (for example, 50 percent) (Step S205). If the number of times in which a face does not appear is less than the predetermined proportion for the captured images acquired during the predetermined period, the looking away determination unit 14 does not determine that the driver is looking away, and returns to the process of determining whether to start the looking away determination.

In the above-described face detection process, when the driver is wearing glasses or a mask, the looking away determination unit 14 may determine that a face does not appear in the captured images to an extent allowing continuation of the looking away determination. In this case, the looking away determination unit 14 may determine to end the process.

In the facial direction detection processing, the looking away determination unit 14 determines whether the facial direction in a newly acquired captured image is within a predetermined range (facial direction condition range) with the straight-ahead direction serving as a standard (Step S206). The predetermined range may be a range of 10 degrees to the left and right with the straight-ahead direction serving as a standard. The looking away determination unit 14 may change the width of the predetermined range based on the current vehicle speed. For example, when the speed is low, the driver is more likely to view a wide range. For this reason, the looking away determination unit 14 may broaden the predetermined range (width) such as to 20 degrees to the left and right with the straight-ahead direction serving as a standard. When the facial direction in the newly acquired captured image is within the predetermined range, the looking away determination unit 14 performs a line-of-sight direction detection process. When the facial direction in the newly acquired captured image is not within the predetermined range, the looking away determination unit 14 acquires a looking away determination result for images captured up to a predetermined period in the past (for example, 1 second) with the sensing time of the newly acquired captured image serving as a standard. With regard to those determination results, the looking away determination unit 14 determines whether the number of times in which the face falls within the predetermined range with the straight-ahead direction serving as a standard is a predetermined proportion (for example, 50%) or more (Step S207). The looking away determination unit 14 determines that there is a looking away when the number of times in which the face is within the predetermined range with the straight-ahead direction serving as a standard for the captured images acquired during the predetermined period is not equal to or greater than the predetermined proportion (Step S208). The looking away determination unit 14 may change the value of the predetermined proportion in the process of determining whether the number of times in which the face is within the predetermined range with the straight-ahead direction serving as a standard is the predetermined proportion or greater. For example, the looking away determination unit 14 decreases the value of the predetermined proportion as the vehicle speed decreases. Here, when the speed of the vehicle is low, the possibility that the driver is viewing a wide area is high. In such a case, by lowering the value of the predetermined proportion, even if the driver is viewing a wide area, the driver will not be judged as looking away. For this reason, it is possible to reduce the output of excessive looking away alerts to the driver.

In the line-of-sight direction detection processing, the looking away determination unit 14 determines whether the line-of-sight direction in a newly acquired captured image is within a predetermined range (line-of-sight direction condition range) with the straight-ahead direction serving as a standard (Step S209). The predetermined range may be a range of 10 degrees to the left and right with the straight-ahead direction serving as a standard. When the speed of the vehicle is low, the driver is likely to view a wide area. For this reason, in such case, the looking away determination unit 14 may broaden the predetermined range (width) such as to 20 degrees to the left and right with the straight-ahead direction serving as a standard. When the line-of-sight direction of the face shown in the newly acquired captured image is within the predetermined range, the looking away determination unit 14 does not determine that the driver is looking away, and returns to the processing for determining whether to start looking away determination. When the line-of-sight direction of the face shown in the newly acquired captured image is not within the predetermined range, the looking away determination unit 14 acquires a looking away determination result for images captured up to a predetermined period in the past (for example, 1 second) with the sensing time of the newly acquired captured image serving as a standard. With regard to those determination results, the looking away determination unit 14 determines whether or not the number of times in which the line-of-sight of the driver is within the predetermined range with the straight-ahead direction serving as a standard is a predetermined proportion (for example, 50%) or more (Step S210). The looking away determination unit 14 determines that the driver is looking away when the number of times in which the line-of-sight of the driver is within the predetermined range with the straight-ahead direction serving as a standard for the captured images acquired during the predetermined period is not equal to or greater than the predetermined proportion (Step S211). The looking away determination unit 14 may change the value of the predetermined proportion in the process of determining whether the number of times in which the line-of-sight of the driver is within the predetermined range with the straight-ahead direction serving as a standard is the predetermined proportion or greater. For example, the looking away determination unit 14 decreases the value of the predetermined proportion as the vehicle speed decreases. Here, as described above, when the speed of the vehicle is low, the possibility that the driver is viewing a wide area is high. In such a case, even if the driver views a wide area, the driver will not be judged as looking away. As a result, it is possible to reduce the output of excessive looking away alerts to the driver.

Upon having determined that looking away is being performed, the looking away determination unit 14 instructs the determination result output unit 15 to output a looking away determination result. The determination result output unit 15 acquires the ID of the drive recorder 2 associated with the data used when a determination is made that looking away is being performed. The determination result output unit 15 acquires the network address that is the transmission destination from the database 104 on the basis of the ID of the drive recorder 2. The network address of the transmission destination is recorded in the database 104 in advance. The determination result output unit 15 transmits information indicating looking away detection to the transmission destination (Step S212). The determination result output unit 15 may record information indicating the looking away detection in the database 104 in association with the ID of the drive recorder 2 or the ID of the driver. The looking away determination unit 14 determines whether to end the process (Step S213). If the process is not ended, the looking away determination device 1 then repeats the same process at a predetermined interval using the processing received from the drive recorder 2.

The drive recorder 2 receives information indicating that looking away of the driver has been detected. Upon receiving the information of looking away detection, the drive recorder 2 performs a process of notifying the driver of the looking away detection, such as issuing an alarm sound. This enables the driver to become aware of the looking away driving.

In the above process, the looking away determination device 1 connected to a communication network as a cloud server performs looking away determination. However, the drive recorder 2 may independently perform the above-described process of looking away determination. That is, the drive recorder 2 may operate as the looking away determination device 1. In this case, the drive recorder 2 may exhibit the same functions as the above-mentioned information acquisition unit 12, the looking away start determination unit 13, the looking away determination unit 14, and the determination result output unit 15. Alternatively, a vehicle-mounted device mounted in the vehicle and connected to the drive recorder 2 may exhibit the same functions as the information acquisition unit 12, the looking away start determination unit 13, the looking away determination unit 14, and the determination result output unit 15. In this case, the vehicle-mounted device operates as the looking away determination device 1.

According to the above-mentioned process, even if the facial direction or the line-of-sight direction cannot be detected, it is possible to detect looking away of the driver depending on whether or not the face can be detected.

In addition, the above-described process outputs an alert when the facial direction or line-of-sight direction has shifted by a predetermined proportion in a predetermined period, without presenting an alert indicating that looking away has been detected just by a slight deviation in the facial direction or line-of-sight direction. Thereby, it is possible to reduce the output of unnecessary looking away detection alerts to the driver.

In addition, the above-described looking away determination device 1 avoids detecting that the driver is looking away in a situation where the line-of-sight deviates from the forward direction, in the case of driving at a speed equal to or lower than a predetermined speed, such as driving at a low speed. Thereby, it is possible to reduce the output of unnecessary looking away detection alerts to the driver.

In addition, the above-described looking away determination device 1 performs a process of broadening the range with the straight-ahead direction serving as a standard for the case of determining that there is a possibility of a looking away determination, in response to a decrease in the speed of the vehicle. For that reason, it is possible to perform looking away determination based on an appropriate range of the facial direction or the line-of-sight direction according to the speed.

In addition, in the process of determining whether the number of times in which the line-of-sight is within the predetermined range with the straight-ahead direction serving as a standard is equal to or greater than a predetermined proportion, the looking away determination device 1 lowers the value of that predetermined proportion as the speed decreases. Thereby, it is possible to perform looking away determination based on an appropriate range of the facial direction or the line-of-sight direction according to the speed.

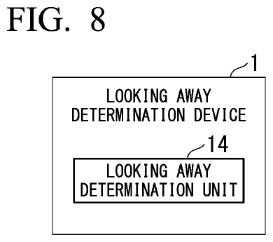

FIG. 8 is a diagram showing a configuration of a looking away determination device according to another example embodiment of the present invention.

The looking away determination device 1 only need to include at least the looking away determination unit 14. The looking away determination unit 14 determines whether or not a face could be detected based on a captured image, and determines that there is a looking away state when the time during which a face cannot be detected is a predetermined proportion or more per unit time.

The looking away determination device 1 and the drive recorder 2 described above have a computer system inside. The process of each process described above is stored in a computer-readable recording medium in the form of a program, with the above process being performed by the computer reading and executing the program. Here, the computer-readable recording medium refers to a magnetic disk, a magneto-optical disk, a CD-ROM, a DVD-ROM, a semiconductor memory, or the like. Further, the computer program may be distributed to a computer via a communication line, and the computer that receives the distribution may execute the program.

Also, the above program may be for realizing some of the functions described above. Further, the program may be a so-called differential file (differential program) that can realize the functions described above in combination with a program already recorded in the computer system.

While a number of example embodiments of the present invention have been described above, it should be understood that they have been presented by way of example, and do not limit the scope of the invention. It will be understood that various additions, omissions, substitutions and modifications may be made to these example embodiments within the scope not departing from the spirit of the invention.

The example embodiments described above may also be described entirely or in part by the following supplementary notes, without being limited to the following.

### Supplementary Note 1

A looking away determination device comprising:

a determination unit that determines that a driver is in a looking away state when a proportion of an image in which the face of the driver is not detected with respect to a plurality of images obtained by imaging the driver is equal to or greater than a first predetermined value.

### Supplementary Note 2

The looking away determination device according to supplementary note 1, wherein the determination unit determines that the driver is in the looking away state when a proportion of an image in which a facial direction of the driver is not in a facial direction condition range with respect to the plurality of images obtained by imaging the driver is equal to or greater than a second predetermined value.

### Supplementary Note 3

The looking away determination device according to supplementary note 2, wherein the determination unit determines that the driver is in the looking away state when a proportion of an image in which a line-of-sight direction of the driver is not in a line-of-sight direction condition range with respect to the plurality of images obtained by imaging the driver is equal to or greater than a third predetermined value.

### Supplementary Note 4

The looking away determination device according to any one of supplementary notes 1 to 3, wherein the determination unit decides whether to determine whether the driver is in the looking away state based on driving situation information indicating a situation during driving by the driver.

### Supplementary Note 5

The looking away determination device according to supplementary note 4,

wherein the driving situation information is speed of a vehicle that is being driven by the driver, and

the determination unit decides to determine whether the driver is in the looking away state when the speed is equal to or greater than a predetermined value.

### Supplementary Note 6

The looking away determination device according to supplementary note 4,

wherein the driving situation information is acceleration of a vehicle that is being driven by the driver, and

the determination unit decides to determine whether the driver is in the looking away state when the acceleration is equal to or greater than a predetermined value.

### Supplementary Note 7

The looking away determination device according to supplementary note 4,

wherein the driving situation information is weather information indicating weather, and
the determination unit decides to determine whether the driver is in the looking away state when the weather information indicating a predetermined weather.

### Supplementary Note 8

The looking away determination device according to supplementary note 4,

wherein the driving situation information is driving operation information indicating a driving operation on a vehicle by the driver, and

the determination unit decides to determine whether the driver is in the looking away state when the driving operation information indicates a predetermined driving operation.

### Supplementary Note 9

The looking away determination device according to supplementary note 1, wherein the determination unit detects the face of the driver from each of the plurality of images.

### Supplementary Note 10

The looking away determination device according to supplementary note 1,

wherein the determination unit detects the face of the driver from a first image captured last among the plurality of images, and

the determination unit detects the face of the driver from each of the plurality of images when the face of the driver is not detected from the first image.

### Supplementary Note 11

The looking away determination device according to supplementary note 10,

wherein the determination unit detects a facial direction of the driver from the first image when the face of the driver is detected from the first image, and

the determination unit determines whether the detected facial direction is within a facial direction condition range.

### Supplementary Note 12

The looking away determination device according to supplementary note 11,

wherein the determination unit, when it is not determined that the detected facial direction is within the facial direction condition range, detects the facial direction of the driver from each of the plurality of images, and

the determination unit determines the driver to be in the looking away state when a proportion of an image in which the facial direction of the driver is not in the facial direction condition range is equal to or greater than a second predetermined value.

### Supplementary Note 13

The looking away determination device according to supplementary note 11 or 12,

wherein the determination unit detects a line-of-sight direction of the driver from the first image, when it is determined that the detected facial direction is within the facial direction condition range, and

the determination unit determines whether the detected line-of-sight direction is within a line-of-sight direction condition range.

### Supplementary Note 14

The looking away determination device according to supplementary note 13,

wherein the determination unit, when it is not determined that the detected line-of-sight direction is within the line-of-sight direction condition range, detects the line-of-sight direction of the driver from each of the plurality of images, and

the determination unit determines that the driver is in the looking away state when a proportion of an image in which the line-of-sight direction of the driver is not in the line-of-sight direction condition range with respect to the plurality of images is equal to or greater than a third predetermined value.

### Supplementary Note 15

A looking away determination system comprising an imaging device and a looking away determination device, the imaging device and the looking away determination device being connected by a communication network,

wherein the looking away determination device comprises a determination unit that determines that a driver is in a looking away state when a proportion of an image in which the face of the driver is not detected with respect to a plurality of images obtained by imaging the driver by the imaging device is equal to or greater than a first predetermined value.

### Supplementary Note 16

A looking away determination method comprising:

determining that a driver is in a looking away state when a proportion of an image in which the face of the driver is not detected with respect to a plurality of images obtained by imaging the driver is equal to or greater than a first predetermined value.

### Supplementary Note 17

A storage medium that stores a program that causes a computer to execute:

determining that a driver is in a looking away state when a proportion of an image in which the face of the driver is not detected with respect to a plurality of images obtained by imaging the driver is equal to or greater than a first predetermined value.

This application is based upon and claims the benefit of priority from Japanese Patent Application No. 2018-51590, filed Mar. 19, 2018, the disclosure of which is incorporated herein in its entirety.

### INDUSTRIAL APPLICABILITY

The present invention may be applied to a looking away determination device, a looking away determination system, a looking away determination method and a storage medium.

### REFERENCE SYMBOLS

1: Looking away determination device

2: Drive recorder

11: Control unit

12: Information acquisition unit

13: Looking away start determination unit

14: Looking away determination unit

15: Determination result output unit

21: Acceleration sensor

23: Camera

24: Control device

241: Vehicle information acquisition unit

242: Weather information acquisition unit

243: Acceleration information acquisition unit

244: Captured image acquisition unit

245: Driving state data transmission unit

246: Captured image transmission unit

1. A looking away determination device comprising:
a memory configured to store instructions; and
a processor configured to execute the instructions to:
determine unit that determines that a driver is in a looking away state when a proportion of an image in which the face of the driver is not detected with respect to a plurality of images obtained by imaging the driver is equal to or greater than a first predetermined value.

2. The looking away determination device according to claim 1, wherein the processor is configured to execute the instructions to: determine that the driver is in the looking away state when a proportion of an image in which a facial direction of the driver is not in a facial direction condition range with respect to the plurality of images obtained by imaging the driver is equal to or greater than a second predetermined value.

3. The looking away determination device according to claim 2, wherein the processor is configured to execute the instructions to: determine that the driver is in the looking away state when a proportion of an image in which a line-of-sight direction of the driver is not in a line-of-sight direction condition range with respect to the plurality of images obtained by imaging the driver is equal to or greater than a third predetermined value.

4. The looking away determination device according to claim 1, wherein the processor is configured to execute the instructions to: decide whether to determine whether the driver is in the looking away state based on driving situation information indicating a situation during driving by the driver.

5. The looking away determination device according to claim 4,
wherein the driving situation information is speed of a vehicle that is being driven by the driver, and
deciding comprises deciding to determine whether the driver is in the looking away state when the speed is equal to or greater than a predetermined value.

6. The looking away determination device according to claim 4,
wherein the driving situation information is acceleration of a vehicle that is being driven by the driver, and
deciding comprises deciding to determine whether the driver is in the looking away state when the acceleration is equal to or greater than a predetermined value.

7. The looking away determination device according to claim 4,
wherein the driving situation information is weather information indicating weather, and
deciding comprising deciding to determine whether the driver is in the looking away state when the weather information indicating a predetermined weather.

8. The looking away determination device according to claim 4,
wherein the driving situation information is driving operation information indicating a driving operation on a vehicle by the driver, and
deciding comprising deciding to determine whether the driver is in the looking away state when the driving operation information indicates a predetermined driving operation.

9. The looking away determination device according to claim 1, wherein the processor is configured to execute the instructions to: detect the face of the driver from each of the plurality of images.

10. The looking away determination device according to claim 1, wherein the processor is configured to execute the instructions to:
try to detect the face of the driver from a first image captured last among the plurality of images; and
detect the face of the driver from each of the plurality of images when the face of the driver is not detected from the first image.

11. The looking away determination device according to claim 10, wherein the processor is configured to execute the instructions to:
detect a facial direction of the driver from the first image when the face of the driver is detected from the first image; and
determine whether the detected facial direction is within a facial direction condition range.

12. The looking away determination device according to claim 11, wherein the processor is configured to execute the instructions to:
when it is not determined that the detected facial direction is within the facial direction condition range, detect the facial direction of the driver from each of the plurality of images; and
determine the driver to be in the looking away state when a proportion of an image in which the facial direction of the driver is not in the facial direction condition range is equal to or greater than a second predetermined value.

13. The looking away determination device according to claim 11, wherein the processor is configured to execute the instructions to:
detect a line-of-sight direction of the driver from the first image, when it is determined that the detected facial direction is within the facial direction condition range; and
determine whether the detected line-of-sight direction is within a line-of-sight direction condition range.

14. The looking away determination device according to claim 13, wherein the processor is configured to execute the instructions to:
when it is not determined that the detected line-of-sight direction is within the line-of-sight direction condition range, detect the line-of-sight direction of the driver from each of the plurality of images, and
determine that the driver is in the looking away state when a proportion of an image in which the line-of-sight direction of the driver is not in the line-of-sight direction condition range with respect to the plurality of images is equal to or greater than a third predetermined value.

15. A looking away determination system comprising:
the looking away determination device according to claim 1; and
a camera that is connected with the looking away determination device by a communication network, and obtains the plurality of images by imaging.

16. A looking away determination method comprising:
determining that a driver is in a looking away state when a proportion of an image in which the face of the driver is not detected with respect to a plurality of images obtained by imaging the driver is equal to or greater than a first predetermined value.

17. A non-transitory computer-readable storage medium that stores a program that causes a computer to execute:
determining that a driver is in a looking away state when a proportion of an image in which the face of the driver is not detected with respect to a plurality of images obtained by imaging the driver is equal to or greater than a first predetermined value.
